(19) United States
(12) Patent Application Publication
(10) Pub. No.: US 2022/0314758 A1
(43) Pub. Date: Oct. 6, 2022

(54) ROLLER DOOR ASSEMBLIES AND METHODS FOR ATTACHING ROLLER DOOR ASSEMBLIES TO VEHICLES

(71) Applicant: Rivian IP Holdings, LLC, Plymouth, MI (US)

(72) Inventors: Parth Shah, Novi, MI (US); Braden Adcock, Newport Beach, CA (US); Jeffrey D. Elliott, Novi, MI (US); Javier Gutierrez, Farmington Hills, MI (US); Rajinder Singh, Plymouth, MI (US)

(21) Appl. No.: 17/217,218

(22) Filed: Mar. 30, 2021

(51) Int. Cl. B60J 5/10; B60J 5/14; E06B 9/15

(52) U.S. Cl. CPC B60J 5/107; B60J 5/14; E06B 9/15; E06B 2009/1555

(57) ABSTRACT

Various disclosed embodiments include illustrative door assemblies, vehicles, and methods of assembling door assemblies. In an illustrative embodiment, a door assembly has a right horizontal track, a left horizontal track, a counterbalance assembly having a right end and a left end, a right connector plate, and a left connector plate. The right connector plate is configured to be connected to the right horizontal track and to the right end of the counterbalance assembly. The left connector plate is configured to be connected to the left horizontal track and to the left end of the counterbalance assembly.

### INTRODUCTION

The present disclosure relates to vehicle manufacturing. The statements in this section merely provide background information related to the present disclosure and may not constitute prior art.

Vehicle manufacturing is a highly time-dependent process. Moving assembly lines in vehicle assembly facilities may typically stop periodically for a time period in order to mount various subsystems, such as door subsystems or the like. In such scenarios, shorter time cycles in assembly lines are desirable over longer time cycles.

### BRIEF SUMMARY

Various disclosed embodiments include illustrative door assemblies, vehicles, and methods of assembling door assemblies on vehicles.

In an illustrative embodiment, a door assembly has a right horizontal track, a left horizontal track, a counterbalance assembly having a right end and a left end, a right connector plate, and a left connector plate. The right connector plate is configured to be connected to the right horizontal track and to the right end of the counterbalance assembly. The left connector plate is configured to be connected to the left horizontal track and to the left end of the counterbalance assembly.

In another illustrative embodiment, a vehicle includes a chassis, a cab configured to cover the chassis, first attachment devices mounted within a wall and a ceiling of the cab, a door assembly, and second attachment devices. The door assembly includes a right horizontal track, a left horizontal track, a counterbalance assembly having a right end and a left end, a right connector plate, and a left connector plate. The right connector plate is configured to be connected to the right horizontal track and to the right end of the counterbalance assembly. The left connector plate is configured to be connected to the left horizontal track and to the left end of the counterbalance assembly. The second attachment devices are configured to attach the door assembly to the first attachment devices.

In another illustrative embodiment, a method includes providing a previously assembled overhead door assembly, providing a left vertical track and a right vertical track, placing the overhead door assembly into a mounting position within a cargo bay of a cab of a vehicle, attaching the overhead door assembly to the cab, and attaching the left vertical track and the right vertical track to respective connector plates of the attached overhead door assembly and to a wall of the cab.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is a perspective view of a vehicle with a rear roller door assembly.

FIG. 2 is a perspective view of an overhead door assembly of the rear roller door assembly of FIG. 1.

FIG. 3 is a plan view of a counterbalance assembly included in the overhead door assembly of FIG. 2.

FIG. 4 is a perspective view of the overhead door assembly and vertical tracks of the rear roller door assembly of FIG. 1.

FIG. 5 is a perspective view of components of the rear roller door assembly of FIG. 1.

FIG. 6 is a perspective view of components of an assembly line for the vehicle of FIG. 1.

FIG. 7 is a perspective view of a stage of mounting the overhead door assembly of FIG. 2.

FIG. 8 is a perspective view of a stage of mounting the overhead door assembly of FIG. 2.

FIG. 9 is a perspective view of a stage of mounting the overhead door assembly of FIG. 2.

FIG. 10 is a flow chart diagram of an illustrative process for manufacturing components of the vehicle of FIG. 1.

Like reference symbols in the various drawings generally indicate like elements.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Various disclosed embodiments include illustrative door assemblies, vehicles, and methods of assembling door assemblies.

Given by way of non-limiting overview, in an illustrative embodiment a door assembly has a right horizontal track, a left horizontal track, a counterbalance assembly having a right end and a left end, a right connector plate, and a left connector plate. The right connector plate is configured to be connected to the right horizontal track and to the right end of the counterbalance assembly. The left connector plate is configured to be connected to the left horizontal track and to the left end of the counterbalance assembly. It will be appreciated that various embodiments may help contribute to reducing assembly time of the door assembly from that for currently known door assemblies.

It will also be appreciated that various embodiments may be used in any structure with an overhead door assembly, such as without limitation a structure with a cargo bay. Given by way of non-limiting examples, various embodiments may be used in vehicles with an overhead door assembly, such as vans with a cargo bay (like cargo vans or delivery vans or the like), delivery trucks with a cargo bay, and the like. By way of further non-limiting example, various embodiments may be used in trailers (like trailers towed by a semi-truck). By way of further non-limiting example, various embodiments may be used in structures with an overhead door assembly such as storage containers, storage facilities, and buildings (including but not limited to modular buildings) with a cargo bay or the like.

For sake of brevity, illustrative examples are provided herein by way of illustration only and not of limitation in which various embodiments are discussed in a setting of a vehicle such as a van and in a setting of installing various embodiments in a vehicle such as a van on an assembly line such as a moving assembly line. However, it will be appreciated that, as discussed above, various embodiments may be used in any structure with a cargo bay and no limitation to use in a vehicle (such as a van) is intended and no such limitation is to be inferred. It will also be appreciated that various embodiments may be used in any assembly setting and are not limited to a setting of an assembly line of any kind including a moving assembly line. No such limitation of disclosed embodiments to an assembly line of any kind is intended and no such limitation is to be inferred.

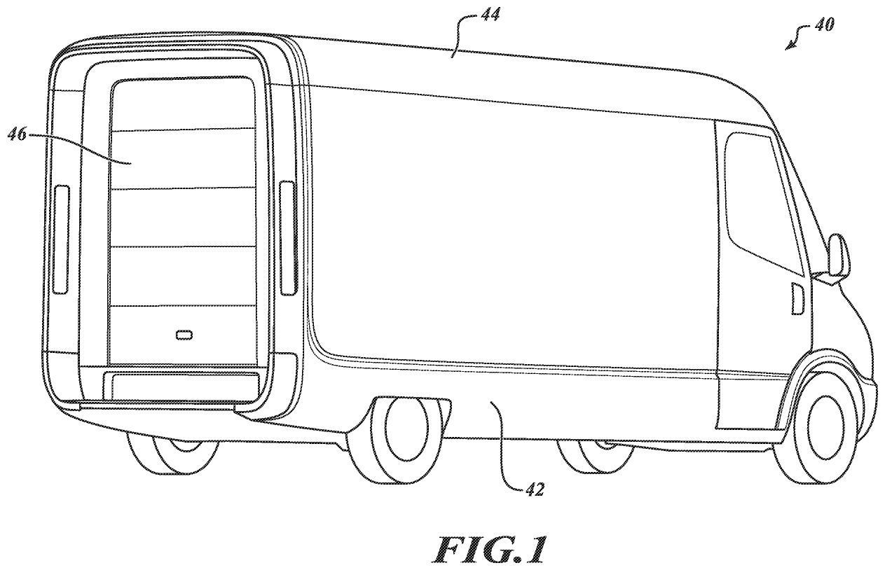

Referring now to FIG. 1, in various embodiments a vehicle 40 includes a chassis 42, a cab 44 that is mounted on top of the chassis 42, and a rear roller door assembly 46 attached to a ceiling and an interior rear wall of the cab 44. In various embodiments, it will be appreciated that the vehicle 40 may include any type of vehicle with a cargo bay as desired for a particular application, such as a van like a cargo van or a delivery van, a delivery truck, or the like. First attachment devices (not shown) are mounted within the interior rear wall and the ceiling of the cab 44.

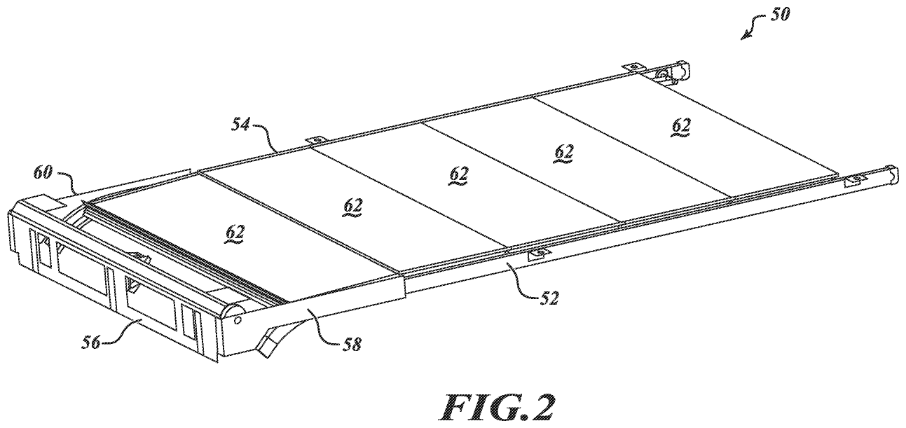

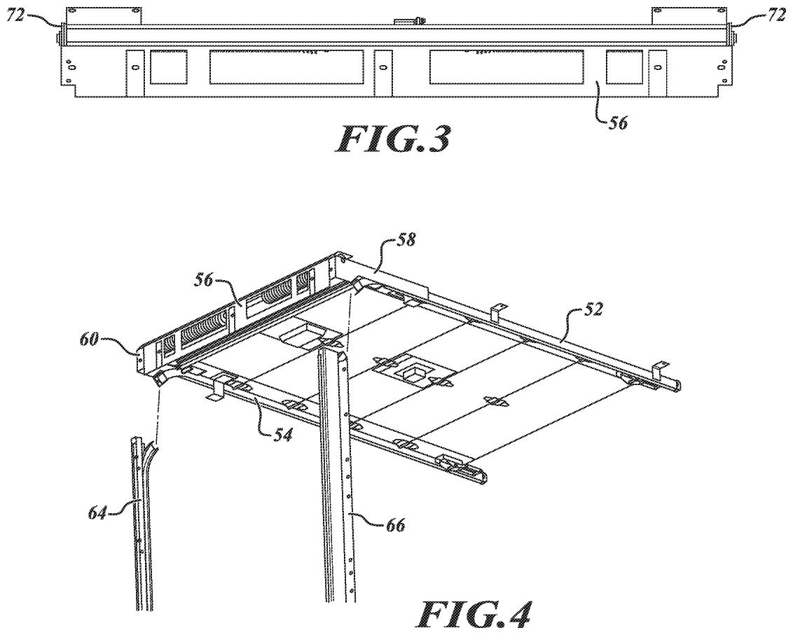

Referring additionally to FIGS. 2-5, in various embodiments the rear roller door assembly 46 includes an overhead door assembly 50 that includes a right horizontal track 52, a left horizontal track 54, a counterbalance assembly 56 having a right end and a left end, a right connector plate 58, a left connector plate 60, multiple door panels 62, multiple hinges (not shown) that connect to the door panels 62, and multiple roller assemblies (not shown). The right connector plate 58 attaches to the right horizontal track 52 and to the right end of the counterbalance assembly 56. The left connector plate 60 attaches to the left horizontal track 54 and to the left end of the counterbalance assembly 56. The roller assemblies connect to the door panels 62 and are rotatably received within the right horizontal track 52 and the left horizontal track 54, respectively.

In various embodiments the counterbalance assembly 56 includes a shaft (not shown), a pre-loaded torsion biasing member 70, such as a torsion spring, a cable drum 72 attached to the shaft, and a cable 74 received by the cable drum 72 and attached to a bottom one of the door panels 62. The pre-loaded torsion biasing member 70 applies a torsion force to the shaft for countering the weight of the door panels 62.

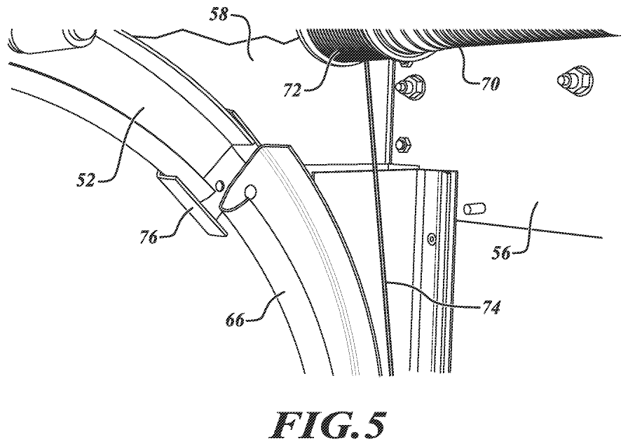

In various embodiments, the rear roller door assembly 46 further includes a left vertical track 64 and a right vertical track 66 (FIG. 4). The left vertical track 64 and the right vertical track 66 are attached to the cab 44 and attached to the left connector plate 60 and the right connector plate 58, respectively.

Referring additionally to FIG. 5, in various embodiments the left connector plate 60 and the right connector plate 58 include respective tracking guides 76. The right horizontal track 52 includes, at a distal end thereof, a curved track section 80 that is received by the tracking guide 76 of the right connector plate 58. The right vertical track 66 includes, at a top end thereof, a curved track section 82 that is received by the tracking guide 76 of the right connector plate 58. The curved track section 80 and/or the curved track section 82 are attached to the tracking guide 76 with a fastener, such as, without limitation, rivets, nuts and bolts, adhesives, weld points/seams, and/or comparable attachment mechanisms. In a mirror image of FIG. 5, the left horizontal track 54 includes, at a distal end thereof, a third curved track section (not shown) that is received by the tracking guide (not shown) of the left connector plate 60, and the left vertical track 64 includes, at a top end thereof, a fourth curved track section (not shown) that is received by the tracking guide (not shown) of the left connector plate 60.

It will be appreciated that the left connector plate 60 and the right connector plate 58 may be attached to the counterbalance assembly 56 and the respective left horizontal track 54 or the right horizontal track 52 using fasteners such as, without limitation, nuts and bolts, rivets, adhesives, weld points/seams, and/or comparable attachment mechanisms.

In various embodiments, connector plates may be an extension of horizontal tracks or a counterbalance assembly by a machining, a molding, or a comparable process.

It will be appreciated that connector plates may be temporarily attached to the counterbalance assembly 56 and the respective horizontal tracks 52 and 54. Once the overhead door assembly with the temporarily-attached connector plates has been attached within the cab 44, if desired the temporarily-attached connector plates may be removed, returned to an overhead door assembly manufacturer, and reused on subsequent overhead door assemblies.

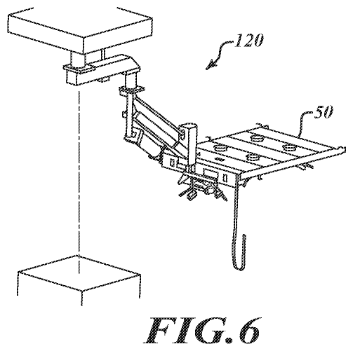

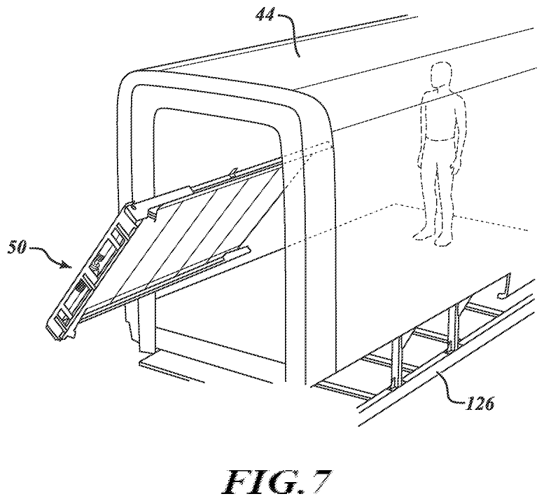

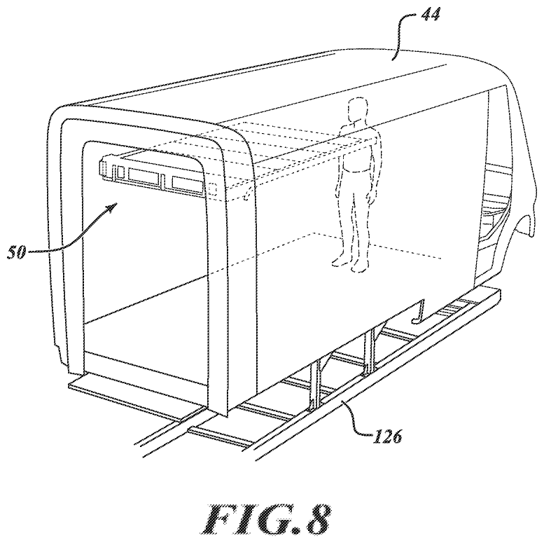

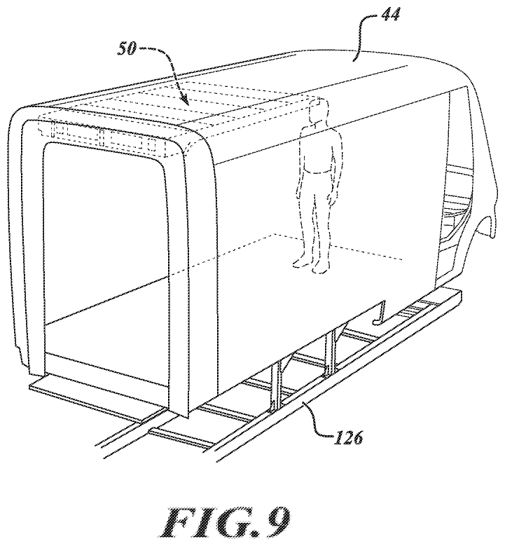

Referring additionally to FIGS. 6-9, in various embodiments a van assembly line includes a lift assembly 120. The lift assembly 120 is mounted to an overhead assembly line structure (not shown), such that the lift assembly 120 is able to move from a pallet 124 that is configured to store multiple overhead door assemblies 50 to a cargo bay of the cab 44 mounted on a cab support 126. In various embodiments the cab support 126 moves on an assembly line (not shown) and stops near the pallet 124 for a predefined period of time to allow an operator to use the lift assembly 120 to grab one of the overhead door assemblies 50 from the pallet 124, rotate the overhead door assembly 50 to a predefined angle (FIG. 7), and move the overhead door assembly 50 into the cargo bay of the cab 44. After the overhead door assembly 50 is fully within the cargo bay of the cab 44, the overhead door assembly 50 is rotated back to a horizontal position (FIG. 8) and is lifted into a mounting position within cargo bay of the cab 44. In the mounting position, fastening locations or brackets on or attached to the horizontal tracks 52 and 54 and the counterbalance assembly 56 are aligned with fasteners previously mounted into the ceiling and aft interior wall of the cargo bay of the cab 44. An operator attaches the overhead door assembly 50 to the ceiling and the aft wall of the cargo bay of the cab 44 (FIG. 9) by applying fasteners to the previously-mounted fasteners. The lift assembly 120 is detached from the overhead door assembly 50 and removed from the cargo bay of the cab 44. The operator continues attaching the overhead door assembly 50 to the ceiling and the aft wall of the cargo bay of the cab 44 according to a predefined assembly instructions. The left vertical track 64 and the right vertical track 66 are then attached to the rear wall of the cargo bay of the cab 44, thus completing the assembly of the rear roller door assembly 46 and allowing the assembly line to move the cab 44 and the cab support 126 to the next assembly line station.

It will be appreciated that the lift assembly 120 may grab the overhead door assembly 50 with suction cups, robotic arms, or comparable devices. Also, the lift assembly 120 may include electrical actuators, hydraulic actuators, or comparable devices.

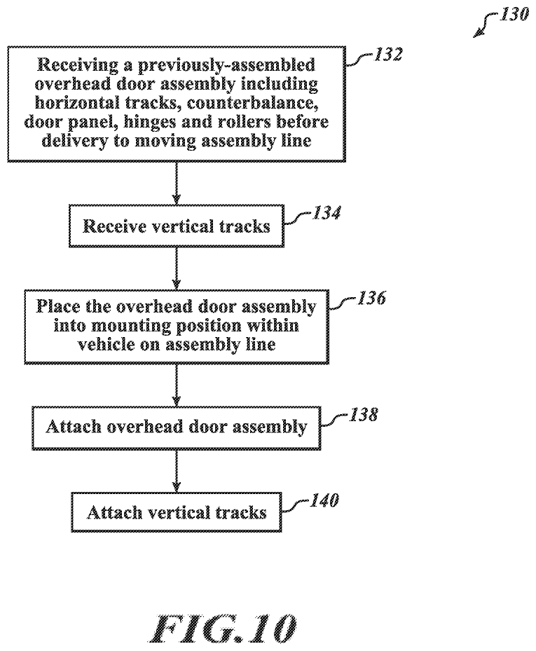

Referring additionally to FIG. 10, an illustrative process 130 may be performed for assembling a van or vehicle or structure that includes an overhead door assembly. At a block 132, a previously-assembled overhead door assembly is received (for example, at an assembly plant, facility, site, or the like). At a block 134, a left vertical track and a right vertical track are received (for example, at the assembly plant, facility, site, or the like). At a block 136, the overhead door assembly is placed into a mounting position within a cargo bay of a structure. At a block 138, the overhead door assembly is attached to the structure. At a block 140, the left vertical track and the right vertical track are attached to respective connector plates of the attached overhead door assembly and to an interior wall of the structure.

In some embodiments, the overhead door assembly may be placed into a mounting position within the cargo bay of the structure at the block 136 by applying a gripping force to the overhead door assembly using a mechanical lift device, rotating the overhead door assembly, inserting the rotated overhead door assembly through an aft portal into the cargo bay, rotating the overhead door assembly into a mounting orientation, and positioning the overhead door assembly to align attachment locations of the previously-assembled overhead door assembly with attachment devices previously embedded within a wall of the cargo bay and a ceiling of the cargo bay.

In some embodiments, the left vertical track and the right vertical track may be attached to respective connector plates of the attached overhead door assembly at the block 140 by attaching an end of the left vertical track and an end of the right vertical track to track guides on respective connector plates.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

What is claimed is:

1. A door assembly comprising:
a right horizontal track;
a left horizontal track;
a counterbalance assembly having a right end and a left end;
a right connector plate configured to be connected to the right horizontal track and to the right end of the counterbalance assembly; and
a left connector plate configured to be connected to the left horizontal track and to the left end of the counterbalance assembly.

2. The door assembly of claim 1, wherein the left connector plate includes a tracking guide and the right connector plate includes a tracking guide.

3. The door assembly of claim 2, further comprising:
a left vertical track; and
a right vertical track.

4. The door assembly of claim 3, wherein:
the right horizontal track includes, at a distal end thereof, a first curved track section configured to be received by the tracking guide of the right connector plate;
the left horizontal track includes, at a distal end thereof, a second curved track section configured to be received by the tracking guide of the left connector plate;
the left vertical track includes, at a top end thereof, a third curved track section configured to be received by the tracking guide of the left connector plate; and
the right vertical track includes, at a top end thereof, a fourth curved track section configured to be received by the tracking guide of the right connector plate.

5. The door assembly of claim 4, wherein at least one curved track section chosen from the first curved track section, the second curved track section, the third curved track section, and the fourth curved track section is attached to its respective tracking guide.

6. The door assembly of claim 1, further comprising:
a plurality of door panels;
a plurality of hinges configured to hingedly connect the plurality of door panels; and
a plurality of roller assemblies configured to be connected to the plurality of door panels and to be rotatably received within the horizontal tracks.

7. The door assembly of claim 6, wherein the counterbalance assembly includes:
a shaft;
a pre-loaded torsion biasing member configured to apply a torque force to the shaft;
a cable drum attachable to the shaft; and
a cable receivable by the cable drum and attachable to a bottom one of the plurality of door panels.

8. The door assembly of claim 1, wherein the connector plate is further configured to:
apply a force between the counterbalance assembly and the left horizontal track;
apply a force between the counterbalance assembly and the right horizontal track; and
be removable after the right horizontal track, the left horizontal track, and the counterbalance assembly have been attached to a cargo bay of a structure.

9. The door assembly of claim 8, wherein the connector plate includes:
a right connector plate configured to be connected to the right horizontal track and to the right end of the counterbalance assembly; and
a left connector plate configured to be connected to the left horizontal track and to the left end of the counterbalance assembly.

10. A vehicle comprising:
a chassis;
a cab configured to cover the chassis;
a plurality of first attachment devices mounted within a wall and a ceiling of the cab;
a door assembly including:
a right horizontal track;
a left horizontal track;
a counterbalance assembly having a right end and a left end; and
a right connector plate configured to be connected to the right horizontal track and to the right end of the counterbalance assembly; and
a left connector plate configured to be connected to the left horizontal track and the left end of the counterbalance assembly; and
a plurality of second attachment devices configured to attach the door assembly to the plurality of first attachment devices.

11. The vehicle of claim 10, wherein:
the right connector plate includes a first tracking guide; and
the left connector plate includes a second tracking guide.

12. The vehicle of claim 11, wherein the door assembly further includes:
a left vertical track; and
a right vertical track.

13. The vehicle of claim 12, wherein:
the right horizontal track includes, at a distal end thereof, a first curved track section configured to be received by the tracking guide of the right connector plate;
the left horizontal track includes, at a distal end thereof, a second curved track section configured to be received by the tracking guide of the left connector plate;
the left vertical track includes, at a top end thereof, a third curved track section configured to be received by the tracking guide of the left connector plate; and
the right vertical track includes, at a top end thereof, a fourth curved track section configured to be received by the tracking guide of the right connector plate.

14. The vehicle of claim 10, wherein the door assembly further includes:
a plurality of door panels;
a plurality of hinges configured to hingedly connect the plurality of door panels; and
a plurality of roller assemblies configured to connect to the plurality of door panels and to be rotatably received within the horizontal tracks.

15. The vehicle of claim 14, wherein the counterbalance assembly includes:
a shaft;
a pre-loaded torsion biasing member configured to apply a torque force to the shaft;
a cable drum attachable to the shaft; and
a cable receivable by the cable drum and attachable to a bottom one of the plurality of door panels.

16. The vehicle of claim 10, wherein the connector plate is further configured to:
apply a force between the counterbalance assembly and the left horizontal track;
apply a force between the counterbalance assembly and the right horizontal track; and
be removable after the right horizontal track, the left horizontal track, and the counterbalance assembly have been attached to a cargo bay of a vehicle.

17. The vehicle of claim 16, wherein the connector plate includes:
a right connector plate configured to be connected to the right horizontal track and to the right end of the counterbalance assembly; and
a left connector plate configured to be connected to the left horizontal track and to the left end of the counterbalance assembly.

18. A method comprising:
receiving a previously-assembled overhead door assembly;
receiving a left vertical track and a right vertical track;
placing the overhead door assembly into a mounting position within a cargo bay of a structure;
attaching the overhead door assembly to the structure; and
attaching the left vertical track and the right vertical track to respective connector plates of the attached overhead door assembly and to a wall of the structure.

19. The method of claim 18, wherein placing the overhead door assembly into a mounting position within the cargo bay of the structure includes:
applying a gripping force to the overhead door assembly using a mechanical lift device;
rotating the overhead door assembly;
inserting the rotated overhead door assembly through an aft portal into the cargo bay;
rotating the overhead door assembly into a mounting orientation; and
positioning the overhead door assembly to align attachment locations of the previously-assembled overhead door assembly with attachment devices previously embedded within a wall of the cargo bay and a ceiling of the cargo bay.

20. The method of claim 19, wherein attaching the left vertical track and the right vertical track to respective connector plates of the attached overhead door assembly includes:
attaching an end of the left vertical track and an end of the right vertical track to track guides on respective connector plates.
